(19) United States
(12) Patent Application Publication
(10) Pub. No.: US 2026/0097681 A1
(43) Pub. Date: Apr. 9, 2026

(54) BATTERY PACKS WITH REMOVABLE POWER CELLS FOR ELECTRIC VEHICLES AND ELECTRIC POWER TRANSMISSION

(71) Applicant: Research Foundation of the City University of New York, New York, NY (US)

(72) Inventor: John-Thones Amenyo, Jamaica, NY (US)

(21) Appl. No.: 19/345,599

(22) Filed: Sep. 30, 2025

Related U.S. Application Data
(60) Provisional application No. 63/702,786, filed on Oct. 3, 2024.

(51) Int. Cl. B60L 53/80; B60L 58/12; B60L 58/18; H01M 10/658; H01M 50/24; H01M 50/249; H01M 50/262

(52) U.S. Cl. CPC B60L 53/80; B60L 58/12; B60L 58/18; H01M 10/658; H01M 50/24; H01M 50/249; H01M 50/262; B60L 2200/10; B60L 2200/26; B60L 2200/32

(57) ABSTRACT

A method for transmitting electrical power to a remote location. A power cell is charged and then transported to a distal location where it is installed into a battery system. The battery system has multiple sets of power cells and utilizes a first set before switching to a second set. When the first set is depleted, it is removed and transported to a charging station for recharging.

### CROSS-REFERENCE TO RELATED APPLICATIONS

This application claims priority to, and is a non-provisional of, U.S. Patent Application 63/702,786 (filed Oct. 3, 2024), the entirety of which is incorporated herein by reference.

### BACKGROUND OF THE INVENTION

Whenever there is a geographical separation between the locations of electric power generation (and storage) and locations of power consumption and utilization, there are challenges of power transmission and distribution. The extant solutions to address this long-distance separation problem rely on power transmission and distribution using high voltage direct current (HVDC) and high voltage alternating current (HVAC) power infrastructures (e.g. power transmission lines). There are well-known issues and challenges associated with using power transmission lines. The issues include challenges of obtaining permits; obtaining new right-of-way or upgrading an existing right-of-way; construction and deployment costs; land preparation and transmission and distribution equipment installation, overhead or underground deployment; and environmental impacts, such as potential sources of wildfires, environmental esthetics, impacts on land use for other purposes; and difficulty of scaling, power regulation to meet balance requirements of demand and supply. Installation of new, or upgrades of existing, cable-based transmission and distribution projects are usually costly multi-year efforts. These transmission and distribution issues are currently faced by utility grid operators contemplating or planning grid modernization, as well as operators of data centers faced with insatiable demands for power to be used for platforms and multi-sided platforms for e-commerce, social media, high performance computing, crypto-mining, and artificial intelligence (AI) data processing.

Despite these challenges, there is ongoing worldwide effort to achieve electrification of the global economy at all scales. This economic transition is considered urgent to achieve zero-emissions of carbon dioxide and other greenhouse gases, and thus lead to the mitigation of the deleterious effects of climate change. Of particular interest is the electrification of transport vehicles, aiming to convert vehicles using fossil fuel-based internal combustion engines into all-electric vehicles. Of significant interest are battery-powered electric vehicles that use electrochemical batteries as the source of power to drive the vehicles.

Battery recharging after battery energy depletion is a common procedure for the operation of battery-powered electric vehicles. Almost all extant battery-powered electric vehicles have the requirement that the electric vehicle must be physically present at the location of the charging equipment. That is, the whole physical vehicle and the charging station are required to be co-located for the duration of the charging of the electric vehicle's battery. Current practical charging times are from 10 min (fast charging) to 2 hours (120 min), and from 2 hours to 12 hours, for overnight charging. High voltage fast charging is considered to degrade and shorten the life of the batteries.

The existing solutions attempt to shorten battery charging time through the use battery swapping of removable battery packs. Battery swapping is also available for automobiles and heavy-duty land vehicles. In these cases, the main battery is typically targeted. In automobiles, such main batteries are in the underbody or undercarriage of the automobile. In heavy-duty land vehicles and buses the main battery can be located at the cabs, roofs or elsewhere in or on the vehicle. The battery is swapped by replacing the whole battery, including the framework by which the battery is attached. Current battery swapping methods have the disadvantage of requiring the use of robots, heavy lifting equipment and/or a special, purpose-built structure called a swapping station.

The discussion above is merely provided for general background information and is not intended to be used as an aid in determining the scope of the claimed subject matter.

### SUMMARY

This disclosure provides a method for transmitting electric power to a remote location. A power cell is charged and then transported to a distal location where it is installed into a battery system. The battery system has multiple sets of power cells and utilizes a first set before switching to a second set. When the first set is depleted, it is removed and transported to a charging station for recharging. An advantage that may be realized in the practice of some disclosed embodiments is that the electric vehicle does not need to be in physical proximity to the charging location.

In a first embodiment, a method for transmitting electrical power to a remote location is provided. The method comprising: charging a power cell at a first charging location, thereby producing a charged power cell; transporting the charged power cell to a distal location; installing the power cell into a battery system located at the distal location, wherein the battery system comprises a plurality of power cells; utilizing electricity from the battery system that comprises at least a first set of power cells and a second set of power cells, the utilizing occurring such that the first set of power cells are utilized before the second set of power cells, thereby producing at least one discharged power cell; removing the at least one discharged power cell from the battery system; and transporting the at least one discharged power cell to a second charging location which may be the same or different than the first charging location.

This brief description of the invention is intended only to provide a brief overview of subject matter disclosed herein according to one or more illustrative embodiments and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a flow diagram depicting one method for managing a remote power transmission system.

FIG. 2 is a schematic depiction of a battery system.

FIG. 3 is a schematic depiction of a power cell for use in the battery system.

FIG. 4 is a schematic depiction of a ground vehicle with the battery system.

FIG. 5 is a schematic depiction of a water vehicle with the battery system.

FIG. 6 is a schematic depiction of an aerodyne with the battery system.

FIG. 7 is a schematic depiction of an aerostat with the battery system.

FIG. 8 is a schematic depiction of a power cell in a charging harness.

FIG. 9 depicts a system for delivering recharged power cells to an electric vehicle from a mobile supply vehicle.

FIG. 10 depicts a system for delivering recharged power cells to an electric vehicle from a stationary charging station.

FIG. 11 depicts a system for delivering recharged power cells that are incorporated into a drone to an electric vehicle.

FIG. 12 depicts a system for delivering recharged power cells that are incorporated into a satellite spacecraft to a spacecraft.

### DETAILED DESCRIPTION OF THE INVENTION

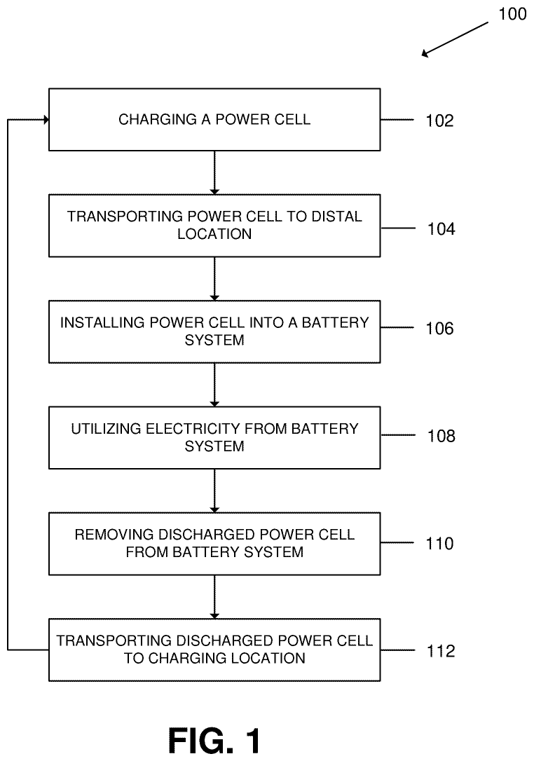

Referring to FIG. 1, a method 100 for managing a remote power transmission system. In step 102, a power cell is charged at a charging location. The power cell may be, for example, a chemical battery. Examples of chemical batteries include rechargeable batteries (e.g. Li-ion, NiCd, nickel-metal hydride, lead-acid, LiFePO₄, etc.). Suitable batteries are available from a variety of commercial sources such as CATL®, BYD®, PANASONIC®, LG ENERGY SOLUTION®, SAMSUNG®, CALB, SUNWODA®, etc. The charging location may be any suitable power generation facility including, but not limited to, a fossil fuel power station (e.g. natural gas, oil, etc.), nuclear power or a green power station (e.g. solar, wind, offshore solar, offshore wind, hydroelectric, geothermal, wave-powered, ballistic gravity, space based solar power satellite, etc.), or battery energy storage system (BESS), or other energy storage system such as fuel cells.

In step 104, the power cell is transported to a distal location, such as an electric vehicle (EV) charging station, or an electric grid substation, a BESS, or a data center. A charging location is a geographic area that has a charging station. The charging station is the physical equipment that performs the act of charging. As discussed in detail elsewhere in this specification, step 104 may be executed by a variety of means for transporting including transportation by road vehicles, seacraft, aircraft, train, unmanned aerial vehicle (e.g. drone), satellite spacecraft, cableway, ropeway and zipline, and the like. In some embodiments, the means for transporting is, itself, an electric vehicle. As used in this specification a cableway is a transportation system that uses suspended cables to move cabins or gondolas along a fixed path using a motorized propulsion system. A ropeway is a type of cable way but uses two cables. A zipline is a cableway that provides one-way transportation using gravity and does not use a motorized propulsion system. In those embodiments where the power cell is transported by cableway, ropeway or zipline, the cableway, ropeway or zipline may be dual purposed. For example, existing power lines can be replaced by ziplines that move the power cells to perform step 104.

In step 106, the power cell is installed into a battery system. The battery system comprises a plurality of power cells which, after step 106, includes the newly installed power cell. The plurality of power cells is installed in electrical parallel configuration. In one embodiment, the battery system is a BESS and the power cell is installed into the BESS. The battery system may be an EV, and EV charging station, an electric grid substation, a data center, etc.

In step 108, electricity from the battery system is utilized. For example, the electricity may be used to operate an electric vehicle, supply power to an electric grid substation, or supply power to a data center. As discussed in detail elsewhere in this specification, step 108 selectively consumes electricity from a first set of power cells in the battery system such that some power cells are consumed before others (e.g. before a second set of power cells). A set of power cells comprises at least one, at least two or at least three power cells. The battery system has a sufficient number of power cells such that the electric vehicle or other power utilization system can continue to operate after the first set of power cells has been depleted by switching to a fresh set of power cells. In this manner, the battery system has a mix of charged power cells and discharged power cells.

In step 110, the discharged power cells are removed from the battery system. In step 112, the discharged power cells are transported to a charging location such as in step 102. By utilizing multiple power cells, recharged power cells can be transported (step 104) to the distal location while discharged power cells are simultaneously transported (step 112) to the charging location.

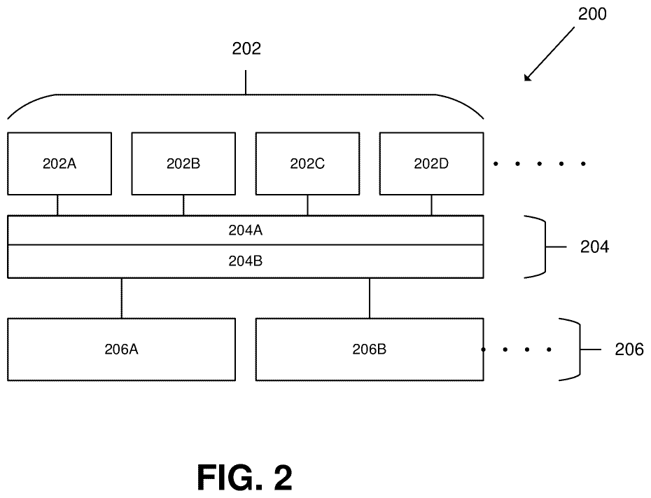

FIG. 2 is a schematic depiction of a battery system 200 for use in an electric vehicle. The battery system 200 comprises a plurality of power cells 202. In the embodiment of FIG. 2, four power cells 202A, 202B, 202C, 202D are shown. In other embodiments, at least two power cells, at least four power cells, at least six power cells or at least ten power cells are present. At least two of the power cells are located at different locations within the electric vehicle or equivalent power utilization unit. For example, power cell 200A may be located in the underbody of the electric vehicle, power cell 200B may be located in a trunk of the electric vehicle, power cell 200C may be located in a roof of the electric vehicle while power cell 200D may be located in under a seat of the electric vehicle. Examples of suitable locations include, but are not limited to, an underbody, a trunk, a frunk, under a seat, a roof, interior cargo space, cargo container, buildings, etc. This delocalization of the battery cells supports flexibility, adaptability, scalability, and accessibility. The use of the battery system 200 and modular power cells 202 also helps to organize the management of the electrical power. The power cells 202 incorporate nested (multi-scale) sub-packs or sub-packaging. In some embodiments, the battery system 200 is also removable from the electric vehicle or equivalent power utilization unit that houses the battery system 200.

Each of the power cells 202 is electrically connected to a power access management system (PAMS) 204 that includes computer hardware (e.g. computer processor) and software for executing predetermined functions according to preprogrammed logic. The PAMS 204 monitors the charge state of each power cell 202 individually using an input monitor 204A. In this manner, PAMS 204 can utilize electricity from a first power cell until it is deemed to be discharged and thereafter begin utilizing electricity of a second power cell. Alternatively, electricity may be simultaneously utilized from a first set of power cells (e.g. from a first and second power cell) until discharged and thereafter begin utilizing electricity from a second set of power cells (e.g. from a third and fourth power cell). A power cell, or set of power cells, may be deemed to be depleted when below a predetermined charge threshold (e.g. less than 5% charge remaining, etc.). In some embodiments, a human readable indicator (e.g. readable message, light indicator, etc.) notifies a human user concerning which power cell is ready for replacement.

By way of illustration, electric automobiles typically require a battery capacity of 50-100 kWh that is provided by a battery that weighs 1000 pounds as a whole. In contrast, the battery system 200 may comprise many smaller power cells that, when managed by the PAMS 204, provides the necessary battery capacity. Because the weight is distributed over multiple power cells, each individual cell is, in some embodiments, light weight enough to be easily handled and managed. For example, each power cell may weigh from 1 pound to 70 pounds, from 1 pound to 20 pounds, from 1 pound to 10 pounds or from 1 pound to 5 pounds, etc.

Similarly, using an output monitor 204B, the PAMS 204 selectively routes electricity to an electrical system 206 that includes one or more electrical subsystems 206A, 206B. For example, subsystem 206A may be the drive train of an electric vehicle while subsystem 206B may be the entertainment system of the electric vehicle. Similarly, the PAMS 204 selectively powers a given subsystem upon demand. For example, the PAMS 204 may power subsystem 206A but not power subsystem 206B.

The embodiment of FIG. 2 depicts two such subsystems, but the number of subsystems is not particularly limited.

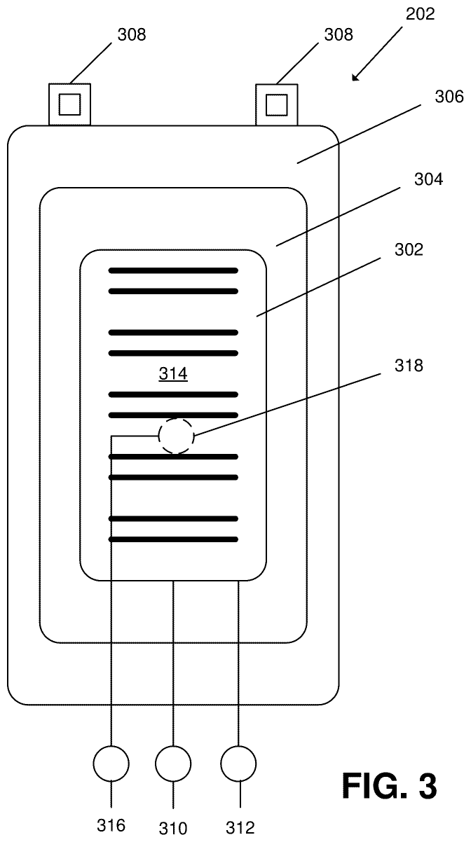

Referring to FIG. 3, a power cell 202 is depicted. Each power cell 202 is an encased, modular power cell that is protected from environmental factors, including dust, high temperature, abrasions, explosions, low temperature, moisture, and salt exposure, using packaging and encapsulation materials. The power cell 202 comprises an electrical housing 302, a thermal housing 304 and an outer housing 306. The electrical housing 302 keeps electricity storage components 314 isolated. The electrical housing 302 is formed of electrically insulating materials. Examples of electrically insulating materials include rubber, glass, plastics (e.g. polyethylene including polyethylene terephthalate, polypropylene, polyimide, polyamide (e.g. aramid fiber), polycarbonate, polyvinyl chloride, polypropylene, polytetrafluoroethylene, silicon, silicates, glass, ceramics, porcelain, fiberglass, mica, aluminum laminates, etc. The electrical housing 302 comprises at least one port that provides one or more connections outside of the outer housing 306. For example, electrical port 310 provides an electrical connection from the electricity storage components 314 to the battery system, thereby permitting the battery system to utilize electricity stored within the power cell 202. Similarly, electrical port 312 provides an electrical connection from the electricity storage components 314 to the PAMS 204, thereby permitting the PAMS 204 to monitor the charge state of the power cell 202. The electrical housing 302 is encased within the thermal housing 304 made of thermal insulation packaging.

The thermal housing 304 provides a layer of insulation about the electrical housing 302. The thermal housing 304 is formed of thermal insulation packaging materials. The thermal housing includes a port 316 that provides an electrical connection to a thermocouple 318 that is in thermal contact with the electrical housing 302. The port 316 is electrically connected to the PAMS 204, thereby permitting the PAMS 204 to monitor the temperature of the power cell 202. If the PAMS 204 detects the power cell 202 is operating outside of a predetermined temperature range the PAMS may selectively stop utilizing electricity from the power cell 202 and switch to a different power cell. The thermal housing 304 is encased within the outer housing 306. Examples of thermal insulation packaging materials include glass aggregates with pozzolans, fiberglass, mineral wood, cellulose, polyurethane, polystyrene aerogel, mica, etc. The thermal housing 304 is non-combustible, non-conductive and absorbent (of both heat and liquids).

The outer housing 306 provides protection from abrasions. The outer housing 306 may be formed from a variety of dielectric materials, such as plastic, metal or wood. The outer housing 306 comprises at least one fastener 308 that permits the power cell 202 to be securely attached to the battery system. The fasteners 308 may be formed of materials that provide additional functionality such an electrical insulation, thermal insulation, shock absorption, and fire retardation.

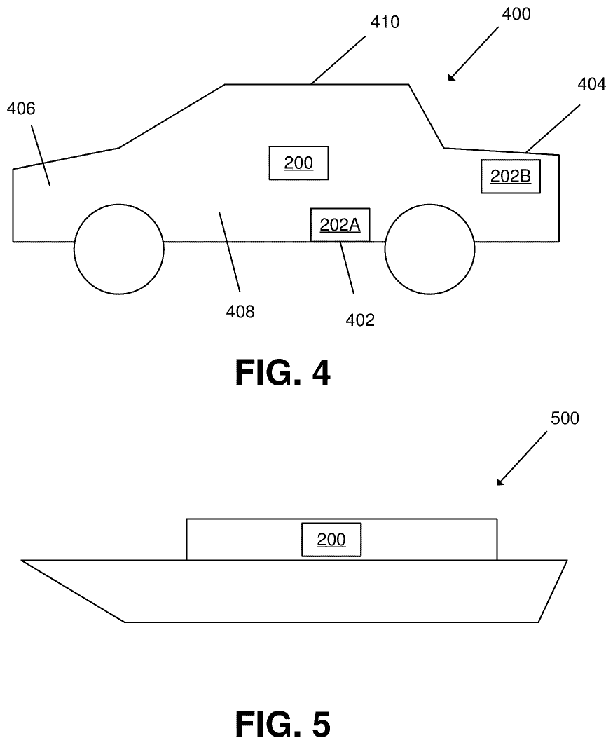

Referring to FIG. 4, a ground vehicle 400 is depicted that comprises the battery system 200. The location of the battery system 200 within the ground vehicle 400 is not particularly limited. Two or more power cells 202 may be located at different locations. For example, power cell 202A is located at an underbody 402 while power cell 202B is located at a trunk 404. Examples of suitable locations include, but are not limited to, a frunk 406, under a seat 408, a roof 410, cargo space, cargo container etc. The ground vehicle 400 may be a variety of ground vehicles including, but not limited to, cars, trucks, railcars, cable cars (e.g. overhead cable cars), buses, vans, motorcycles, e-mobility vehicles and scooters, and other automobiles.

Referring to FIG. 5, a water vehicle 500 is depicted that comprises the battery system 200. The location of the battery system 200 within the water vehicle 500 is not particularly limited. Two or more power cells 202 may be located at different locations. For example, power cells may be individually placed at the bow, the stern, the port side, the starboard side, above deck, below deck, etc. The water vehicle 500 may be a variety of water vehicles including, but not limited to, ships, ferries, barges, boats, etc.

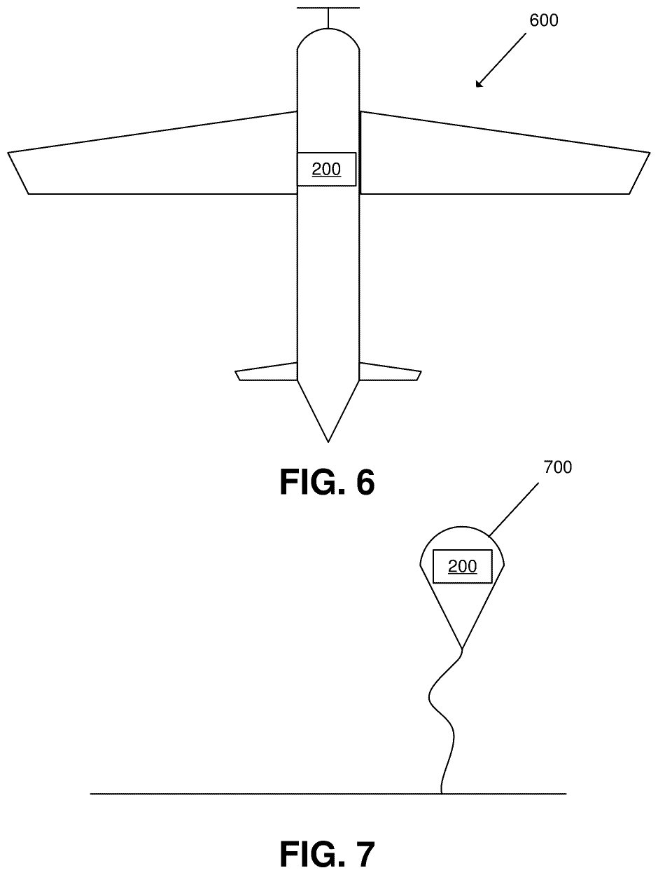

Referring to FIG. 6, an aerodyne 600 is depicted that comprises the battery system 200. The location of the battery system 200 within the aerodyne 600 is not particularly limited. Two or more power cells 202 may be located at different locations. The aerodyne 600 may be a variety of aerodynes including, but not limited to, passenger aircraft (jet or propeller), jet liners, miliary aircraft, helicopters, unmanned aerial vehicles (e.g. drones), etc.

Referring to FIG. 7, an aerostat 700 is depicted that comprises the battery system 200. The location of the battery system 200 within the aerostat 700 is not particularly limited. Two or more power cells 202 may be located at different locations. The aerostat 700 may be a variety of aerostats including, but not limited to, hot air balloons, gas balloons, blimps, zeppelins, surveillance balloons, helikites, etc.

Advantageously, the electric vehicle need not be located at a charging station. The disclosed system has the advantage that, at any time, only a small portion of the battery system needs to be swapped. The disclosed system is also advantageous because there is no need to wait for a charging time of any considerable duration. Extra power cells can be pre-charged and subsequently swapped for discharged battery cells.

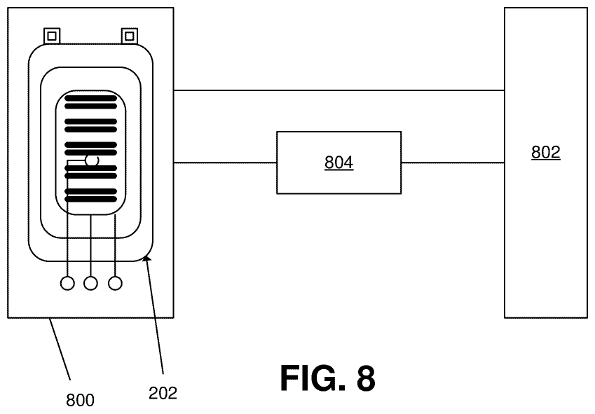

Referring again to FIG. 1, in step 102 a discharged power cell is charged at a charging location. Referring now to FIG. 8, step 102 is executed by installing the power cell 202 into a charging harness 800. Ports 310, 312 and/or 316 are electrically connected to the charging harness 800. A power generation facility 802 generates electricity that is used to recharge the discharged power cell 202. An electrical connection between the power generation facility 802 and the charging harness 800 can be established through conventional means. For example, a direct wired connection 804 may establish the connection. In those embodiments in which the power generation facility 802 cannot establish a suitable direct connection, a charging adaptor 806 may be utilized.

In some embodiments, the power cell 202 is sized such that a human can carry the power cell. For example, the power cell 202 may be sized to weigh between 5 pounds and 15 pounds. In other embodiments, the power cell 202 is sized such that mechanical equipment is used to carry the cell. For example, the power cell 202 may be sized to weigh between 75 pounds and 150 pounds. Examples of suitable mechanical equipment includes forklifts, transport trolleys, cranes, hoists, etc.

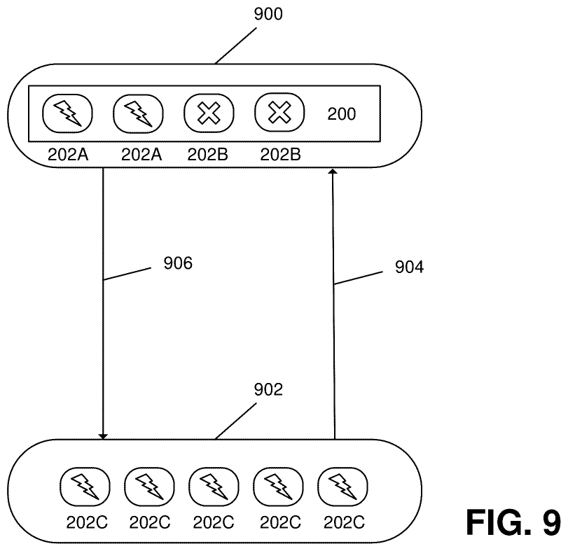

Referring to FIG. 9, a system is depicted for delivering recharged power cells to an electric vehicle while in transit, constituting dynamic refueling. An electric vehicle 900 is depicted that comprises the battery system 200. In the embodiment of FIG. 9, the battery system 200 comprises both charged power cells 202A as well as discharged power cells 202B. A refueling supply vehicle 902 is also depicted. The supply vehicle comprises charged power cells 202. Step 104 (see method 100 of FIG. 1) is executed when charged power cells 202C are transported in the direction of arrow 904 to be placed in the battery system 200. Step 112 (see method 100 of FIG. 1) is executed when discharged power cells 202B are transported in the direction of arrow 906 to be placed in the refueling supply vehicle 902. In some embodiments, the refueling supply vehicle 902 comprises a charging location within the vehicle itself. In other embodiments, the refueling supply vehicle 902 transports the discharged power cells 202B to a distal charging location for subsequent recharging.

The electric vehicle 900 may be a variety of electric vehicles including the ground vehicle 400 (see FIG. 4), the water vehicle 500 (see FIG. 5), the aerodyne 600 (see FIG. 6) or the aerostat 700 (see FIG. 7), or spacecraft (see FIG. 12). Likewise, the refueling supply vehicle 902 may be a variety of vehicles including a ground vehicle, a water vehicle, an aerodyne or an aerostat, or spacecraft. In some embodiments, the refueling supply vehicle 902 is also an electric vehicle. In other embodiments, the refueling supply vehicle 902 is not an electric vehicle. Because both the electric vehicle 900 and the refueling supply vehicle 902 are mobile, the electric vehicle 900 can receive charged power cells 202C while in motion.

The transporting of the charged power cells 202C and the discharged power cells 202B in the direction of arrow 904 and arrow 906, respectively, may be accomplished by a variety of means for transferring. The means for transferring include, for example, manual transfer by the human hand. In other embodiments, the means of transferring is a robotic transfer system. In other embodiments, the means of transferring is a mechanical transfer system, such as a crane, a telehandler, etc. In other embodiments, the means of transferring is an intermediary vehicle such as a forklift, a boom truck, an electric tugger, a skid steer loader, boat, a balloon, an unmanned aerial vehicle (e.g. drone), spacecraft etc.

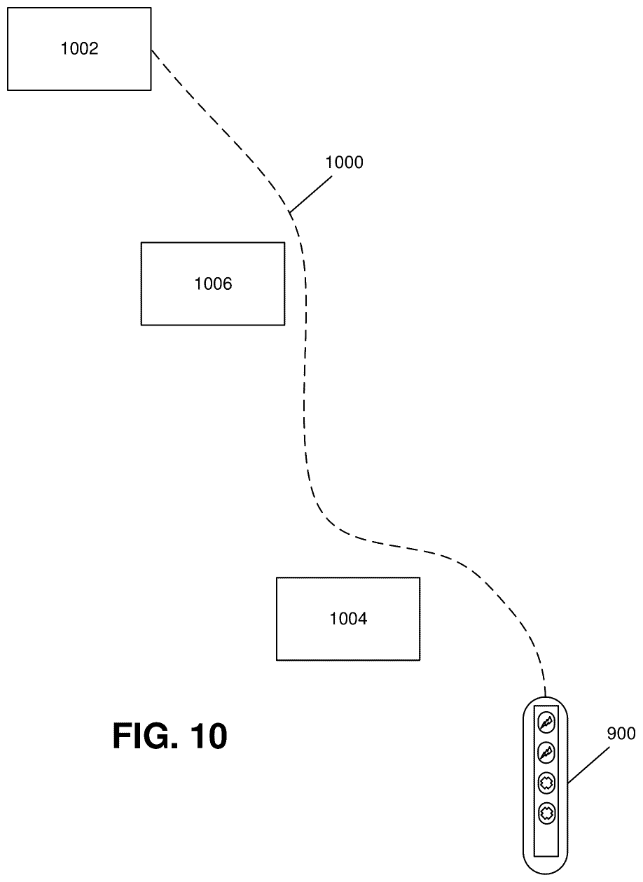

In some embodiments, the charging location may be a charging station that is present at a fixed location. For example, conventional wisdom holds that equipping long-haul ocean-craft with batteries is impractical because of the heavy weight of the battery. With reference to FIG. 10, an electric vehicle 900 may travel across a large body of water along path 1000 toward destination 1002. One or more charging locations equipped with charging stations 1004, 1006 may be located along the path 1000. The charging stations 1004, 1006 can be mobile vehicles. As the electric vehicle 900 approaches each of these charging stations 1004, 1006 depleted power cells are replaced with charged powered cells. In this manner, the electric vehicle 900 can cross a large body of water while carrying only a fraction of the battery weight that would be required by conventional methods. The charging stations 1004, 1006 may be, for example, a floating platform (e.g. human-made floating island), an offshore platform that is anchored to the seabed, submarine, submersible, etc. The charging stations 1004, 1006 may include a power generation facility as discussed elsewhere in this specification. In some embodiments, the charging stations 1004 and/or 1006 are existing offshore platforms (e.g. oil rigs) that have been modified to also serve as charging locations.

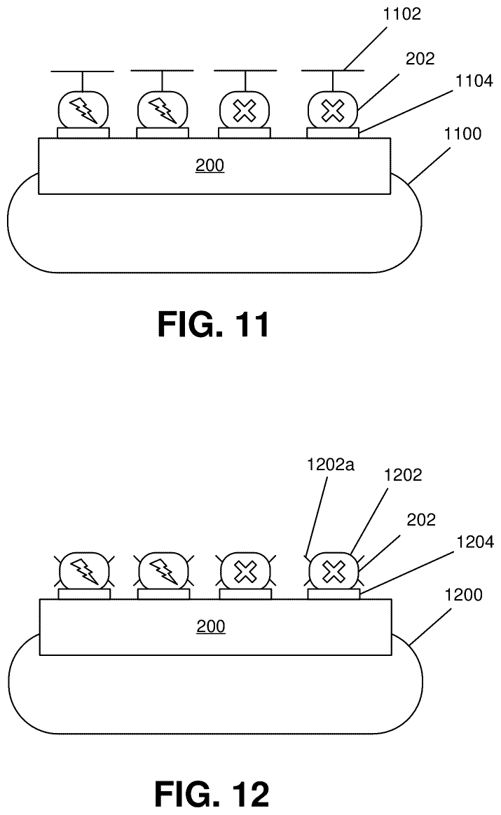

Referring to FIG. 11, an electric vehicle 1100 is depicted that comprises the battery system 200. In FIG. 11, each power cell 202 is integrated into a drone 1102, which functions as a refueling supply vehicle. The lower surface of each power cell 202 is configured to electrically connect to a platform 1104 on an exposed surface of the battery system 200. When a given power cell 202 is deemed to be depleted, the PAMS 204 (see FIG. 2) monitors the location of the electric vehicle until it is proximate to a charging location. The monitoring may occur, for example, using a global positioning system (GPS) or other remote connection to a wireless receiver at the charging location. Once within range, the drone 1102 with the depleted power cell 202 disengages from platform 1104 and docks with the charging location. A corresponding charged power cell is dispatched from the charging location to replace the depleted power cell 202. In one embodiment, the platform 1104 provides a direct electrical connection between the power cell 202 and the battery system 200 (e.g. the platform 1104 is a conductive material). In another embodiment, the electrical connection is indirect (e.g. wireless) and uses induction to transfer electrical power. A variety of systems are known to facilitate docking of drones including optically guided systems, magnetically guided systems, and the like. As discussed elsewhere in this specification, the charging location may be stationary or mobile.

Referring to FIG. 12, an electric vehicle is embodied as a spacecraft 1200 that comprises the battery system 200. The spacecraft 1200 may be, for example, a satellite in orbit. In FIG. 12, each power cell 202 is integrated into a satellite spacecraft 1202, which functions as a refueling supply vehicle. The platform 1204 is configured in a manner similar to the platform 1104 of FIG. 11. The satellite spacecraft is configured for use in a vacuum and comprises thrusters 1202a. In one embodiment, a single thruster is present that is disposed on a gimbal. In one embodiment, the spacecraft 1200 is in orbit around a planet, planetoid or moon. In another embodiment, the space spacecraft stationed a surface of a non-Earth planet, planetoid or moon.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for transmitting electrical power to a remote location, the method comprising:
charging a power cell at a first charging location, thereby producing a charged power cell;
transporting the charged power cell to a distal location;
installing the power cell into a battery system located at the distal location, wherein the battery system comprises a plurality of power cells;
utilizing electricity from the battery system that comprises at least a first set of power cells and a second set of power cells, the utilizing occurring such that the first set of power cells are utilized before the second set of power cells, thereby producing at least one discharged power cell;
removing the at least one discharged power cell from the battery system; and
transporting the at least one discharged power cell to a second charging location which may be the same or different than the first charging location.

2. The method as recited in claim 1, wherein the first set of power cells consists of one power cell.

3. The method as recited in claim 1, wherein the first set of power cells comprises at least two power cells.

4. The method as recited in claim 1, wherein the battery system is disposed within an electric vehicle.

5. The method as recited in claim 4, wherein the electric vehicle is a road vehicle selected from a car, a truck, a railcar, a bus, a van, a motorcycle and a scooter.

6. The method as recited in claim 4, wherein the electric vehicle is a water vehicle selected from a ship, a ferry, a barge, a boat, submarine and a submersible.

7. The method as recited in claim 4, wherein the electric vehicle is an aerodyne selected from an aircraft, a jet liner, a miliary aircraft, a helicopter and an unmanned aerial vehicle.

8. The method as recited in claim 4, wherein the electric vehicle is an aerostat selected from a hot air balloon, a gas balloon, a blimp, a zeppelin, a surveillance balloon and a helikite.

9. The method as recited in claim 4, wherein the electric vehicle is a spacecraft in orbit around a planet, planetoid, moon, or a spacecraft stationed on a surface of a non-Earth planet, planetoid or moon.

10. The method as recited in claim 4, wherein the electric vehicle is a cable car.

11. The method as recited in claim 4, wherein the battery system comprises a sufficient number of power cells such that the electric vehicle continues operation after the first set of power cells has reached a predetermined charge threshold by switching to utilizing electricity from the second set of power cells.

12. The method as recited in claim 1, wherein the power cell comprises electricity storage components that are encapsulated within an electrical housing that is encapsulated within a thermal housing that is encapsulated within an outer housing, the outer housing comprising a fastener that secures the power cell to the battery system.

13. The method as recited in claim 10, wherein the outer housing further comprises an electrical port that electrically connects the electricity storage components to the battery system and an electrical port that electrically connects the electricity storage components to a power access management system (PAMS), the PAMS configured to selectively utilize electricity from power cells within the plurality of power cells.

14. The method as recited in claim 13, wherein the PAMS is configured to monitor a charge state of each power cells within the plurality of power cells.

15. The method as recited in claim 1, wherein the transporting is performed using a cableway, ropeway or zipline.
